(19) United States
(12) Patent Application Publication
(10) Pub. No.: US 2011/0017410 A1
(43) Pub. Date: Jan. 27, 2011

(54) TELESCOPIC COVER

(76) Inventors: Masafumi Yamashita, Mie (JP); Hirotoshi Miyake, Mie (JP); Wataru Yoshimoto, Mie (JP); Takashi Takemoto, Mie (JP)

Correspondence Address: Cheng Law Group, PLLC, 1100 17th Street, N.W., Suite 503, Washington, DC, 20036, US

(21) Appl. No.: 12/715,080

(22) Filed: Mar. 1, 2010

(30) Foreign Application Priority Data
Jul. 21, 2009 (JP) 2009-170401

(51) Int. Cl. E06B 9/06

(52) U.S. Cl. 160/222

(57) ABSTRACT

A novel telescopic cover of the present invention has a plurality of protection covers having top plates and vertically-suspended plates vertically suspended from the top plates, and being arranged so as to cover a guiding portion of a machining tool or the like in a freely stretchable manner between every adjacent pair of the protection covers, while being linked with each other by a linking mechanism which is configured by a plurality of linking elements linked so as to be rotatable around connecting shafts, wherein the telescopic cover has a plurality of guide rails provided to the plurality of protection covers, each having a guide groove which has one and the other guiding surfaces opposed with each other, in the direction normal to the direction of stretching and shrinkage of the entire portion of the protection covers; and a plurality of rolling elements arranged in guide groove, so as to be freely rotatable around each connecting shaft which extends in the depth-wise direction of the guide groove.

### BACKGROUND

1. Technical Field

The present invention relates to a telescopic cover used for covering guiding surface of machine or apparatus, such as machining tool or three-dimensional measuring instrument, while being attached to the machine or apparatus so as to protect their internal mechanical structures.

2. Related Art

Machining tool or three-dimensional measuring instrument is generally provided with a linearly-driven machining head or a measuring unit or the like, and is therefore configured to have a rail-form or shaft-form guiding surface over the range of travel of the machining head and so forth, so as to allow the machining head to travel in a reciprocating manner along the guiding surface. However, adhesion of cutting debris or dust discharged during machining onto the guiding surface may adversely affect accuracy of linear movement of the machining head, or may be causative of disorder. For the purpose of protecting the guiding surface of the machining head and so forth from the dust and so forth, there has therefore been used a telescopic cover having a plurality of protection covers which are arranged in a nested manner, and linked with each other with the aid of a linking mechanism which is composed of a plurality of linking elements. The telescopic cover stretches and shrinks in association with linear travel of the machining head or the like, typically while being fixed on the base side thereof to the main unit of the machining tool, and fixed on the end side thereof to the machining head or the like.

One known telescopic cover is proposed by the present applicant (see Japanese Utility Model Gazette No. 3133056). The telescopic cover has a plurality of protection covers, wherein a guide rail which has a guide groove is fixed to each protection cover. On the other hand, in the vicinity of the end of each linking element which configures the linking mechanism, there is fixed a connecting shaft having the top end thereof engaged in the guide groove of the guide rail. On the upper end side of the connecting shaft, there is formed a disk which slidingly contacts the inner wall of the guide groove.

Sliding resistance, however, generates when the inner wall of the guide groove and the outer circumferential surface of the disk are brought into contact with each other, or when the linking mechanism moves and thereby the connecting shaft moves in the direction normal to the direction of stretching of the telescopic cover. One idea for reducing the sliding contact may be such as providing a single rolling element to the connecting shaft. It is supposed that such provision of a single rolling element to the connecting shaft may allow smooth travel of the connecting shaft, while preventing sliding contact between the inner wall of the guide groove and the rolling element.

However, in the thus-configured telescopic cover, the protection cover disposed most closely to the based side (or end side in some cases) out of the plurality of protection covers may be fixed to an inaccurate position of machine or apparatus, such as machining tool, while being slightly inclined in the vertical direction or transverse direction, or may be applied with an external force in a distorting direction even if it should be fixed to an accurate position. If the center axis (connecting shaft) of the rolling element inclines away from the depth-wise direction of the guide groove as a consequence, a part of the outer circumferential surface of the rolling element may come into contact with both of one guiding surface and the other guiding surface opposed therewith, which compose the guide groove, enough to make the rolling element no more roll, and make it locked. As a matter of course, the locking of the rolling element makes the linking mechanism disabled as a whole, and the telescopic cover can no more stretch and shrink. The machining tool, however, keeps on generating operating force, so that either one of, or both of the machining tool and the telescopic cover may accidentally be broken. While a method of setting of a large (wide) clearance between the outer surface of the rolling element and the guide groove is supposed to be effective in view of avoiding the nonconformity, the method is not successful in accurately guiding the rolling element (connecting shaft) in the direction normal to the direction of stretching of the telescopic cover.

The present invention is proposed to solve the above-described problems in the conventional telescopic cover, wherein an object of which is to provide a novel telescopic cover capable of constantly keeping a rolling state of the rolling element without causing locking of the rolling element on the guiding surface of the guide groove, even if it is inclined away from the depth-wise direction of the guide groove while being applied with external force in a distorting direction, and consequently capable of stably repeating the stretching and shrinking motion.

### SUMMARY

According to a first aspect of the present invention (invention described in claim 1), there is provided a telescopic cover having a plurality of protection covers each having a top plate and a vertically-suspended plate vertically suspended from the top plate, and being arranged so as to cover a guiding portion of a machining tool or the like in a freely stretchable manner between every adjacent pair of the protection covers, while being linked with each other by a linking mechanism which is configured by a plurality of linking elements linked so as to be rotatable around connecting shafts. The telescopic cover has a plurality of guide rails provided to the plurality of protection covers, each having a guide groove which has one and the other guiding surfaces opposed with each other, in the direction normal to the direction of stretching of the entire portion of the protection covers; and a plurality of rolling elements arranged in the guide groove, so as to be freely rotatable around each connecting shaft which extends in the depth-wise direction of the guide groove.

According to the telescopic cover of the first aspect of the present invention, each guide groove formed in a plurality of guide rails is brought into contact with a plurality of rolling elements which are freely rotatable around each connecting shaft, so that frictional resistance, which may generate during stretching and shrinkage of the protection covers corresponded to stretching and shrinkage of the linking mechanism in association with linear travel of machine or apparatus, such as machining tool, may effectively be reduced. Even when the entire portion of, or a part of the protection covers are applied with external force in a distorting direction, and thereby the connecting shafts incline away from the depth-wise direction of the guide groove, the telescopic cover of the present invention can constantly keep a rolling state of a plurality of rolling elements without causing locking of the rolling elements on the guiding surface of each guide groove, and can consequently repeat the stretching and shrinking motion.

According to the telescopic cover of the present invention, since each guide groove has one and the other guiding surfaces opposed with each other, and since each connecting shaft extends in the depth-wise direction of the guide groove, so that even when the connecting shafts are forced to incline away from the depth-wise direction of the guide groove, a part of the plurality of rolling elements comes into contact with one guiding surface, and the other part of the rolling elements always comes into contact with the other guiding surface, so as to keep all rolling elements rotated in both directions. Of course, when all of the plurality of rolling elements rotates while being brought into contact with only either one guiding surface or the other guiding surface, all of the plurality of rolling elements rotate in the same direction. Anyway, an accidental state, in which the plurality of rolling elements are locked in each guide groove and made no more rollable therein, and thereby the linking mechanism and the protection cover as a whole are inhibited to stretch or shrink, may be avoidable in a successful manner.

The rolling element may be good enough if it can rotate around the connecting shaft, while being brought into contact with at least one and the other guiding surfaces of the guide groove, when the linking mechanism stretches or shrinks (and consequently the plurality of protection covers stretch or shrink as a whole) and thereby the connecting shaft moves in the direction normal to the direction of stretching or shrinkage. For example, the rolling element may be configured to have a disk form having the connecting shaft fixed thereto or inserted therethrough at the center thereof, or may be configured as a bearing which is composed of an outer cylinder formed into a cylindrical shape, an inner cylinder fixed at the center thereof to the connecting shaft, and a plurality of balls disposed between the outer cylinder and the inner cylinder.

According to a second aspect of the present invention (invention described in claim 2) , there is provided the telescopic cover as described in the first aspect, wherein each of the guide rails further has: an opening formed between the one and the other guiding surfaces so as to allow the connecting shafts inserted thereinto; and a closing portion opposed with the opening, the width of the inner surface of the closing portion which configures the guide groove is smaller than the diameters of the plurality of rolling elements.

According to the second aspect of the present invention, the width of the inner surface of the closing portion which configures the guide groove is set smaller than the diameters of the plurality of rolling elements, so that even if the rolling element closest to the inner surface of the closing portion, out of the plurality of rolling elements, approaches the inner surface of the closing portion while being applied with an external force, the rolling element does not contact over a wide area rolling element rolling element with the inner surface, when it moves in the longitudinal direction of the guide rail. As a consequence, according to the telescopic cover of the second aspect of the present invention, the frictional resistance between the rolling element and the inner surface of the closing portion may be reduced, and thereby smoother stretching and shrinkage of the linking mechanism, and the protection covers as a whole, may be ensured.

### BRIEF DESCRIPTION OF THE DRAWINGS

FIG. 1 is a perspective view illustrating an appearance of the back of a telescopic cover;

FIG. 2 is a plan view illustrating a stretched state of the telescopic cover;

FIG. 3 is a plan view illustrating a shrunk state of the telescopic cover;

FIG. 4A is a sectional view extractively illustrating only a linking mechanism used in the present invention, taken along line A-A in FIG. 2 (no hatching given to indicate the section), and FIG. 4B is an enlarged sectional view of portion C in FIG. 4A;

FIG. 5 is an enlarged sectional view of portion B in FIG.

4A;

FIG. 6 is an enlarged sectional view illustrating a state of a connecting shaft inclined from the state illustrated in FIG. 5;

FIG. 7 is an enlarged sectional view illustrating another embodiment; and

FIG. 8 is an enlarged sectional view illustrating a state of a connecting shaft inclined from the state illustrated in FIG. 7.

1 telescopic cover

2, 3, 4, 5 first to fourth protection covers

2a, 3a, 4a, 5a top plates

6 linking mechanism

8, 9, 10, 11 vertically-suspended plates

14, 15, 16, 17, 18 guide rails

15a horizontal closing plate

15b left vertically-suspended plate

15c right vertically-suspended plate

19 to 24 first to sixth connecting bars

31 to 39 first to ninth connecting shafts

51 first rolling element

52 second rolling element

### DETAILED DESCRIPTION

A telescopic cover 1 according to a best mode of embodying the present invention will be detailed below, referring to the attached drawings. The telescopic cover 1 of this embodiment is fixed to a machining tool not illustrated.

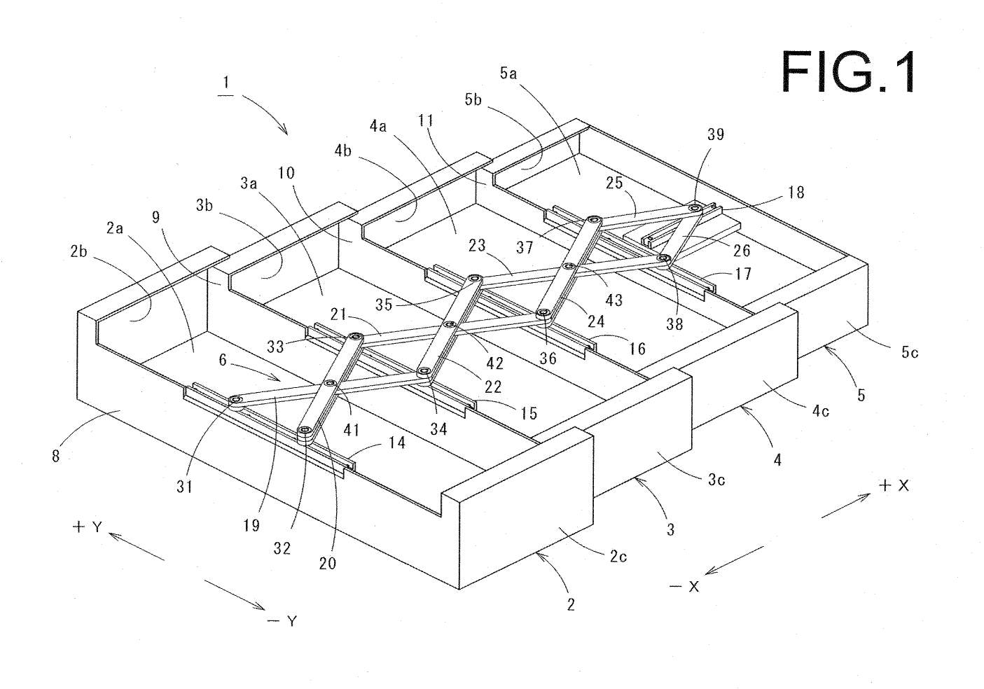

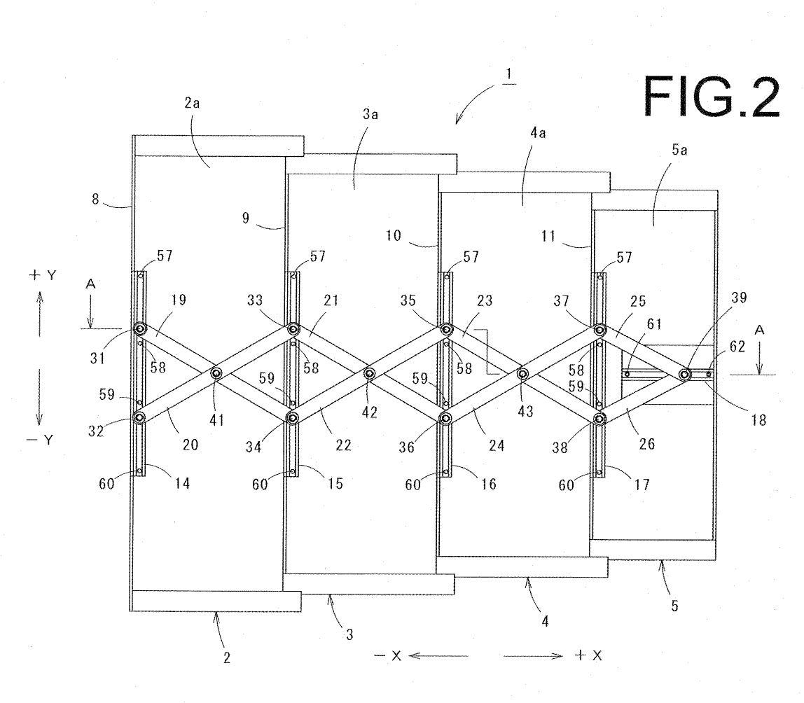

The telescopic cover 1 is composed of iron, and has, as illustrated in FIG. 1, first to fourth protection covers 2, 3, 4, 5, and a linking mechanism 6 provided on the inner side of the first to fourth protection covers 2, 3, 4, 5, and is configured to freely stretchable and shrinkable in the “+X” and “−X” directions, respectively. The first to fourth protection covers 2, 3, 4, 5 have, as illustrated in FIG. 1 and FIG. 2, top plates 2a, 3a, 4a, 5a; left side plates 2b, 3b, 4b, 5b vertically suspended from the left edge of the top plates 2a, 3a, 4a, 5a; right side plates 2c, 3c, 4c, 5c vertically suspended from the right edge of the top plates 2a, 3a, 4a, 5a; and first to fourth vertically-suspended plates 8, 9, 10, 11 welded to the rear edge of the top plates 2a, 3a, 4a, 5a so as to vertically suspend therefrom, respectively.

At the front lower ends of the first to fourth vertically-suspended plates 8, 9, 10, 11, there are fixed first to fourth guide rails 14, 15, 16, 17, respectively, in the direction normal to the direction of stretching of the first to fourth protection covers 2, 3, 4, 5 as a whole. On the top plate 5a of the fourth protection cover 5, there is fixed a fifth guide rail 18 in the same direction with the direction of stretching and shrinkage, while placing a base plate (reference numeral not given) in between.

The first protection cover 2 herein is an element fixed to the main unit of the machining tool not illustrated. On the other hand, the fourth protection cover 5 is an element fixed to a reciprocating machining head not illustrated. The second protection cover 3 is disposed inside the first protection cover 2, the third protection cover 4 is disposed inside the second protection cover 3, and the fourth protection cover 5 is disposed inside the third protection cover 4. The first to fourth protection covers 2, 3, 4, 5 are shaped so as to be nested one after another, which are step-wisely reduced in size in this order. Note that the mode of attachment of the telescopic cover 1 to the machining tool is not limited to the above-described one, and may be such that the smallest fourth protection cover 5 is fixed to the main unit of the machining tool, and the largest first protection cover 2 is fixed to the machining head reciprocating with respect to the main unit of the machining tool.

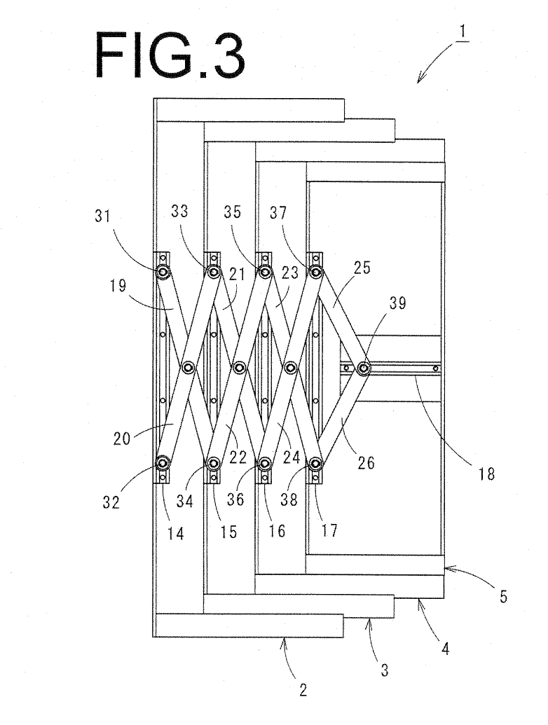

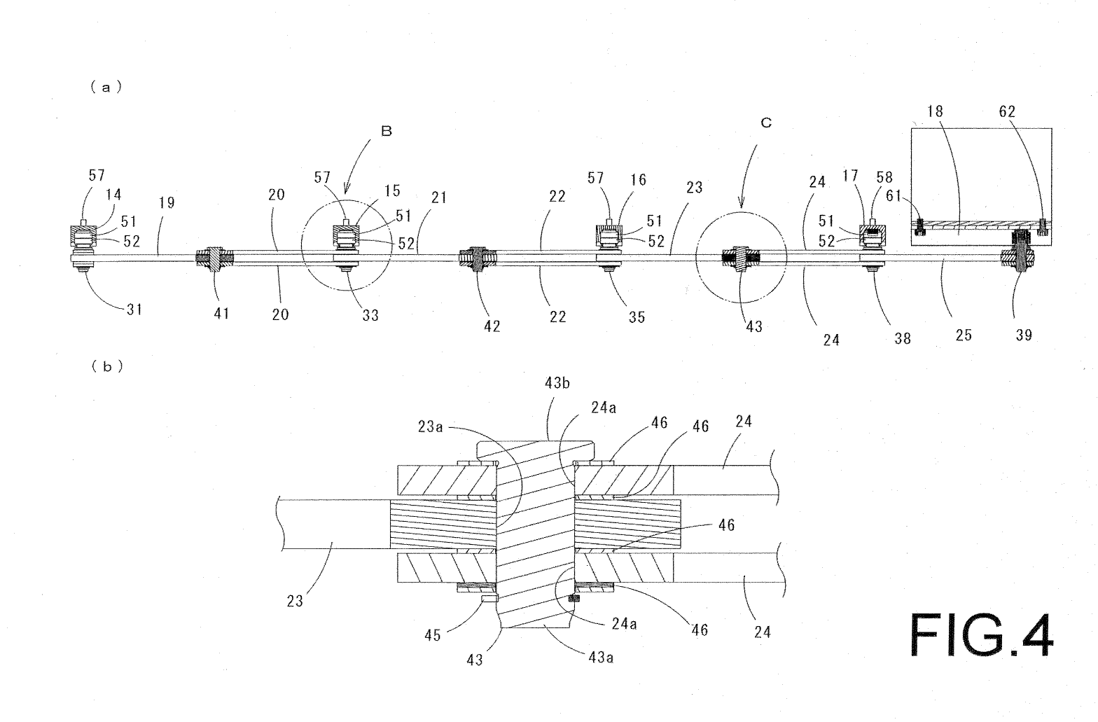

The thus-configured first to fourth protection covers 2, 3, 4, 5 are linked by the first to fourth guide rails 14, 15, 16, 17 each having a guide groove formed in the direction normal to the direction of stretching and shrinkage of the first to fourth protection covers 2, 3, 4, 5 as a whole; the fifth guide rail 18 having a guide groove formed in the direction of stretching and shrinkage of the fourth protection cover 5; first to sixth connecting bars (linking elements of the present invention) 19 to 24 disposed between every adjacent pair of the guide rails 14 to 18 so as to configure the linking mechanism 6; seventh and eighth guide bars 25, 26; first to ninth connecting shaft 31 to 39 respectively engaged, on the upper end sides thereof, with the guide grooves of the guide rails 14 to 18 so as to be slidable in the guide grooves, and respectively supporting, on the lower end sides thereof, the connecting bars 19 to 24 and the guide bars 25, 26 in a freely rotatable manner; and first to third supporting shafts 41, 42, 43 respectively supporting the middle portions of the connecting bars 19 to 24. When the fourth protection cover 5 reciprocates together with the machining head not illustrated, the second and third protection covers 3, 4 stretch and shrink between the stretched state illustrated in FIG. 2 and the shrunk state illustrated in FIG. 3. Of the connecting bars 19 to 24, individual connecting bars 20, 22, 24 are composed of a pair of upper and lower connecting bars formed to have the same geometry, length and width as illustrated in FIG. 1, and the individual paired connecting bars are connected in a freely rotatable manner with the aid of the third connecting shaft 33, fifth connecting shaft 35, seventh connecting shaft 37, and with the aid of the first to third supporting shaft 41, 42, 43, while holding a part of the connecting bars 19, 21, 23, or a part of the guide bar 25 in between. For example, as illustrated in FIGS. 4A and 43, (one) connecting bar 23 and two connecting bars 24, 24 are linked with each other in a freely rotatable manner at the centers thereof with the aid of the third supporting shaft 43. More specifically, as illustrated in FIG. 4B, the connecting bar 23 has a through-hole 23a bored at the center thereof (similarly to the other connecting bars) , also two connecting bars 24, 24 have through-holes 24a bored at the centers thereof, and the third supporting shaft 43 is inserted in the through-holes 23a, 24a, 24a. The third supporting shaft 43 is composed of a rod 43a inserted in the through-holes 23a, 24a, 24a, and a head 43b formed at one end of the rod 43a (similarly to the first and the second supporting shafts 41, 42) . A snap ring 45 is fixed to the lower end of the rod 43a, and a flat washer 46 is disposed respectively between the head 43b and one connecting bar 24, between one connecting bar 24 and the connecting bar 23, between the other connecting bar 24 and the connecting bar 23, and between the snap ring 45 and the other connecting bar 24.

The first to fourth guide rails 14, 15, 16, 17 are fixed to the first to fourth vertically-suspended plates 8, 9, 10, 11 on the lower front side thereof (on the right side) as illustrated in FIG. 2, respectively with the aid of a fixing element not illustrated. The fifth guide rail 18 is fixed to the back side (lower surface) of the top plate 5a, which is disposed ahead (on the right side in the drawing) of the fourth guide rail 17, in the direction normal to the fourth guide rail 17 using two bolts (reference numeral not given). In other words, the first to fourth guide rails 14, 15, 16, 17 are disposed in the direction normal to the direction of stretching and shrinkage of the telescopic cover

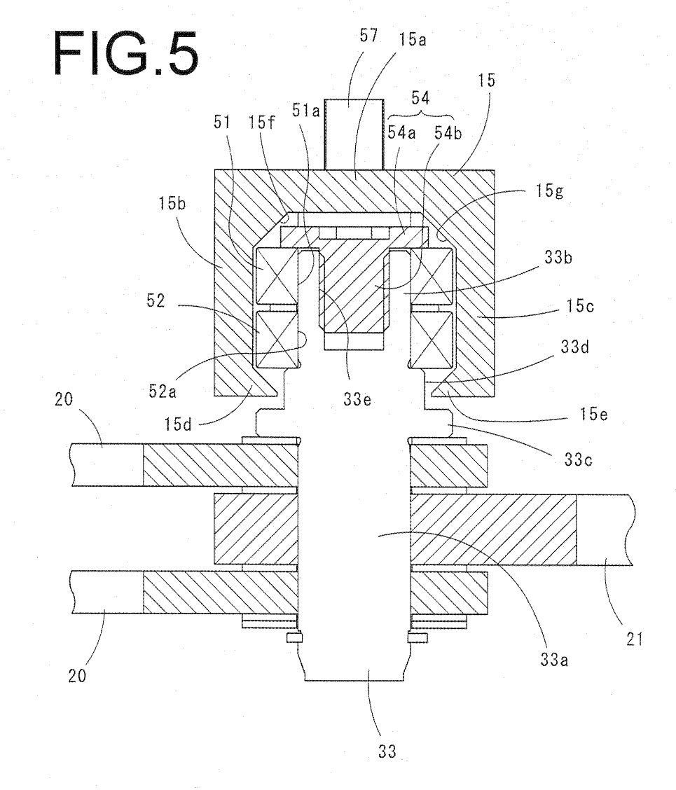

The first to fourth guide rails 14, 15, 16, 17 are configured similarly to the second guide rail 15 illustrated in FIG. 5. For example, as illustrated in the sectional view, the second guide rail 15 is configured by a horizontal closing plate 15a, a left vertically-suspended plate 15b which vertically suspends from the left edge of the horizontal closing plate 15a, a right vertically-suspended plate 15c which vertically suspends from the right edge of the horizontal closing plate 15a and has the inner surface thereof opposed to the left vertically-suspended plate 15b, a left bent portion 15d which is bent at the lower edge of the left vertically-suspended plate 15b towards the center, and a right bent portion 15e which is bent at the lower edge of the right vertically-suspended plate 15c towards the center and has the end face thereof opposed to the end face of the left bent portion 15d, and is formed into an oblong geometry as illustrated in FIG. 1 to FIG. 3. The horizontal closing plate 15a, the left vertically-suspended plate 15b, the right vertically-suspended plate 15c, the left bent portion 15d and the right bent portion 15e cooperatively configure a guide groove (reference numeral not given) inside thereof, wherein the horizontal closing plate 15a corresponds to the closing portion which configures the present invention, the inner surface of the left vertically-suspended plate 15b corresponds to one guiding surface which configures the present invention, and the inner surface of the right vertically-suspended plate 15c corresponds to the other guiding surface which configures the present invention. In the telescopic cover 1 of this embodiment, inclined surfaces 15f, 15g are formed respectively between the horizontal closing plate 15a and the left vertically-suspended plate 15b, and between the horizontal closing plate 15a and the right vertically-suspended plate 15 which compose the second guide rail 15. Accordingly, the width of the lower surface (the surface forming the guide groove) of the horizontal closing plate 15a is made smaller than the diameter of the first and second rolling elements 51, 52 described later. The above-described configuration of the guide rail is equally adaptable to the first to fourth guide rails 14 to 17, including the second guide rail 15.

The first to ninth connecting shafts 31 to 39 are configured similarly to the third connecting shaft 33 illustrated in FIG. 5. The third connecting shaft 33 has a bar connecting rod 33a which connects two upper and lower connecting bars 20, 20 and the connecting bar 21, and an insertion rod 33b integratedly formed with the bar connecting rod 33a, inserted into the second guide rail 15, and provided therearound with the rolling elements described later. The third connecting shaft 33 has a flange 33c which is formed between the bar connecting rod 33a and the insertion rod 33b, and has a diameter larger than the diameters of the bar connecting rod 33a and the insertion rod 33b. The upper end face (reference numeral not given) of the insertion rod 33b has a recess 33e formed therein, which is threaded on the inner circumferential surface thereof to form one threaded portion (reference numeral not given) which serves as a nut. The outer diameter of the flange 33c is set smaller than the width of the second guide rail 15 (length between the outer surface of the left vertically-suspended plate 15b to the outer surface of the right vertically-suspended plate 15c) , and longer than the width of the opening (reference numeral not given) of the second guide rail 15 formed between the left bent portion 15d and the right bent portion 15e.

Above the flange 33c (on the side opposite to the bar connecting rod 33) , there is formed a diameter-enlarged portion 33d having a diameter slightly increased from the outer diameter of the bar connecting rod 33, above which the (first and second) rolling elements 51, 52 which compose the present invention are disposed in a freely rotatable manner. More specifically, in this embodiment, two (first and second) rolling elements 51, 52 are provided to the third connecting shaft 33 (the same will apply also to the first and second connecting shafts 31, 32, and to the fourth to ninth connecting shafts 34 to 39). Both of the first and second rolling elements 51, 52 are composed of stainless steel, formed into a cylindrical geometry, and have insertion holes 51a, 52a bored at the centers thereof, so as to allow the insertion rod 33b, which configures the third connecting shaft 33, to be inserted therethrough. The outer diameters of the first and second rolling elements 51, 52 are respectively set smaller than the distance between the inner surface (rolling surface) of the left vertically-suspended plate 15b and the inner surface (rolling surface) of the right vertically-suspended plate 15c which compose the second guide rail 15 (the width of the guide groove). In other words, a slight clearance is formed between the guide groove of the second guide rail 15 and the outer circumferential surfaces of the first and second rolling elements 51, 52. On the upper end of the insertion rod 33b of the third connecting shaft 33, a bolt 54 is screwed in the threaded portion (nut portion) thereof. The bolt 54 is configured by a disk-form head 54a and a stem 54b, wherein the outer diameter of the head 54a is set smaller than the width of the lower surface of the horizontal closing plate 15a, and set smaller than the outer diameters of the first and second rolling elements 51, 52. The stem 54b is threaded on the outer circumferential surface thereof to form the other threaded portion (reference numeral not given) which is engageable with the above-described one threaded portion formed on the inner circumferential surface of the recess 33e.

The first to sixth connecting bars 19 to 24, and the seventh and eighth guide bars 25, 26 are arranged as described below. As illustrated. in FIG. 2, the first and second connecting bars 19, 20 are arranged to form an X-pattern, and connect the first guide rail 14, with the aid of the first and second connecting shafts 31, 32, to the second guide rail 15, with the aid of the third and fourth connecting shafts 33, 34, while being supported at the X-form intersection with the aid of the first supporting shaft 41 in a freely rotatable manner. Similarly, the third and fourth connecting bars 21, 22 are arranged to form an X-pattern, and connect the second guide rail 15, with the aid of the third and fourth connecting shafts 33, 34, to the third guide rail 16, with the aid of the fifth and sixth connecting shafts 35, 36, while being supported at the X-form intersection with the aid of the second supporting shaft 42 in a freely rotatable manner.

Similarly, the fifth and sixth connecting bars 23, 24 are arranged to form an X-pattern, and connect the third guide rail 16, with the aid of the fifth and sixth connecting shaft 35, 36, to the fourth guide rail 17, with the aid of the seventh and eighth connecting shafts 37, 38, while being supported at the X-form intersection with the aid of the third supporting shaft 43. The seventh and eighth guide bars 25, 26 are arranged to form a V-pattern, and connect the fourth guide rail 17, with the aid of the seventh and eighth connecting shafts 37, 38, to the fifth guide rail 18 with the aid of the ninth connecting shaft 39.

Accordingly, when the fourth protection cover 5 moves to the −X side in association with motion of the machining head not illustrated, the third protection cover 4 is moved to the −X side with the aid of the fifth and sixth connecting bars 23, 24. When the third protection cover 4 thus moves, the second protection cover 3 moves to the −X side with the aid of the third and fourth connecting bars 21, 22, while leaving the first protection cover 2 which is fixed to the main unit of the unillustrated machining tool unmoved, so that the first connecting shaft 31 moves to the +Y side, and the ninth connecting shaft 32 moves to the −Y side.

At the same time, the third, fifth and seventh connecting shafts 33, 35, 37 move to the +Y side, the fourth, sixth and eighth connecting shafts 34, 36, 38 move to the −Y side, and the ninth connecting shaft 39 moves to the −X side. As a consequence, upon movement of the fourth protection cover 5 to the −X side, the distance between every adjacent pair of the protection covers 2, 3, 4, 5 reduces to give a state more similar to that illustrated in FIG. 3, whereas upon movement of the fourth protection cover 5 to the +X side, the distance between every adjacent pair of the protection covers 2, 3, 4, 5 increases to give a state more similar to that illustrated in FIG. 2. In other words, the telescopic covers 1 stretches and shrinks, by the stretching and shrinking action of the linking mechanism 6 which is configured by the first to sixth connecting bars (linking elements of the present invention) 19 to 24, the seventh and eighth guide bars 25, 26, the first to ninth connecting shafts 31 to 39, and rolling/movement of the first and second rolling elements 51, 52 disposed respectively to the first to ninth connecting shafts 31 to 39 so as to roll in the guide grooves of the guide rails 14 to 18.

Positional relation of the first and second rolling elements 51, 52 with respect to the first to fourth guide rails 14, 15, 16, 17 will further be detailed below. When the telescopic cover 1 as a whole shrinks from the stretched state illustrated in FIG. 2 to the shrunk state illustrated in FIG. 3, both of the first rolling element 51 and the second rolling element 52 are respectively guided by one guiding surface which stands across the direction of shrinkage (for example, the inner surface of the left vertically-suspended plate 15b of the second guide rail 15 illustrated in FIG. 5). On the other hand, when the telescopic cover 1 as a whole stretches from the shrunk state illustrated in FIG. 3 to the stretched state illustrated in FIG. 2, both of the first rolling element 51 and the second rolling element 52 are respectively guided by the other guiding surface which stands across the direction of stretching (for example, the inner surface of the right vertically-suspended plate 15c illustrated in FIG. 5).

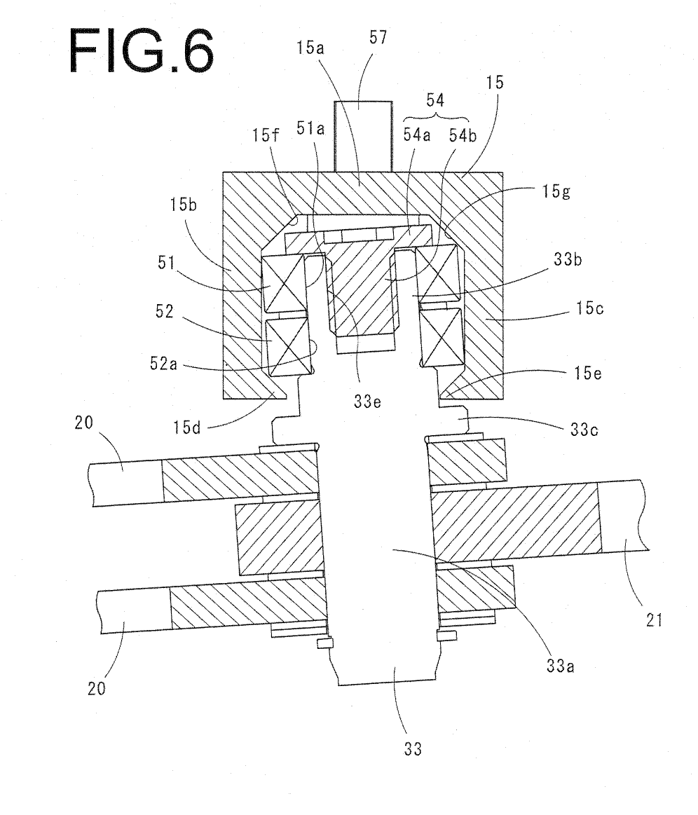

Unlike the case where the telescopic cover 1 normally stretches or shrinks, while keeping both of the first rolling element 51 and the second rolling element 52 rolled on the one guiding surface or the other guiding surface composing the guide groove, any of the first to fourth protection covers 2, 3, 4, 5 composing the telescopic cover 1 may be applied with external force, so that the connecting shaft 33, having been vertically positioned in the depth-wise direction of the guide groove as illustrated in FIG. 5, may incline as illustrated FIG. 6. In this case, the outer circumferential surface of the first rolling element 51 is brought into contact only with the one guiding surface (for example, the inner surface of the left vertically-suspended plate 15b of the second guide rail 15 illustrated in FIG. 6), and the outer circumferential surface of the second rolling element 51 is brought into contact only with the other guiding surface (for example, the inner surface of the right vertically-suspended plate 15c of the second guide rail 15 illustrated in FIG. 6), while preventing the first rolling element 51 from being brought into contact with both of the one guiding surface and the other guiding surface. More specifically, even if the first to eighth connecting shafts 31 to 38 incline away from the depth-wise direction of the guide grooves formed in the first to fourth guide rails 14, 15, 16, 17, the first rolling element 51 or the second rolling element 52 is prevented from being brought into contact with both of the one guiding surface and the other guiding surface, and thereby a part of, or all of the first and second rolling elements are prevented from being locked. Accordingly, the telescopic cover 1 constantly ensures stable stretching and shrinking motion, even if any of the first to fourth protection covers 2, 3, 4, 5 is applied with external force.

In the telescopic cover 1 of this embodiment, the guide groove of each of the first to fourth guide rails 14, 15, 16, 17 has first to fourth stoppers (bolts) 57, 58, 59, 60 provided thereto, as illustrated in FIG. 2. The fifth guide rail 18 has a fifth stopper (bolt) 61 and a sixth stopper (bolt) 62 fixed thereto. The distance between the first stopper 57 and the second stopper 58 is set slightly longer than the range (length) of movement of the first connecting shaft 31, third connecting shaft 33, fifth connecting shaft 35 and seventh connecting shaft 37, and the distance between the third stopper 59 and the fourth stopper 60 is set slightly longer than the range (length) of movement of the second connecting shaft 32, fourth connecting shaft 34, sixth connecting shaft 36 and eighth connecting shaft 38. The distance between the fifth stopper 61 and the sixth stopper 62 is set slightly longer than the range (length) of movement of the ninth connecting shaft 39. Each of the first to sixth stoppers 57 to 62 has the head thereof projected into the guide groove, with which each connecting shaft (reference numeral not given) is brought into contact, and is thereby prevented from outwardly or inwardly moving beyond the positions thereof, so as to prevent the linking mechanism 6 from being disabled in stretching and shrinking.

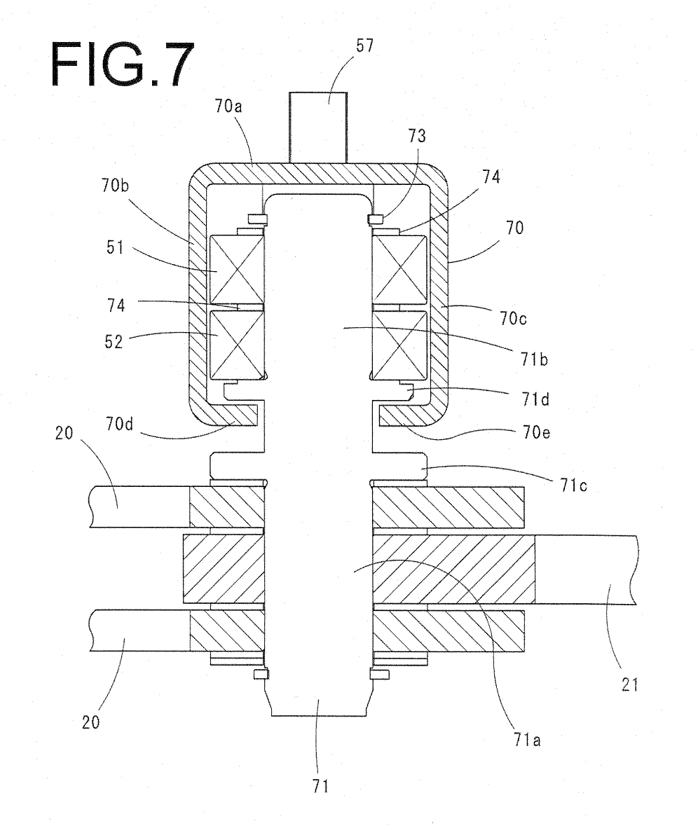

Although the (for example, second) guide rail (15) and the (third) connecting shaft (33) of the telescopic cover 1 of this embodiment have been explained referring to those configured as illustrated in FIG. 5, the guide rails and the connecting shafts composing the present invention are not limited to the above-described configuration, and may be configured as those illustrated in FIG. 7.

A guide rail 70 illustrated in FIG. 7 is formed by bending a metal sheet, and has a closing plate 70a, a left vertically-suspended plate 70b which vertically suspends from the left edge of the closing plate 70a, and a right vertically-suspended plate 70c which vertically suspends from the right edge of the closing plate 70a. Below the closing plate 70a, one bottom. rim 70d extended from the left vertically-suspended plate 70b, and the other bottom rim 70e extended from the right vertically-suspended plate 70c are formed, and an oblong opening (reference numeral not given) is formed between the one bottom rim 70d and the other bottom rim 70e. The inner space of the guide rail 70 corresponds to the guide groove which composes the present invention, the inner surface of the left vertically-suspended plate 70b corresponds to the one guiding surface, and the inner surface of the right vertically-suspended plate 70c corresponds to the other guiding surface.

In the guide rail 70, one end of a connecting shaft 71 is inserted. The connecting shaft 71 is positioned so as to connect the individual connecting bars 20,21 in a freely rotatable manner, similarly to the first to ninth connecting shafts 31 to 39, and has a bar connecting rod 71a which connects the individual connecting bars, and an insertion rod 71b which is integratedly formed with the bar connecting rod 71a, inserted into the guide rail 70, and provided therearound with the rolling elements described later. The connecting shaft 71 has a disk-form outer flange 71c which is formed between the bar connecting rod 71a and the insertion rod 71b, has a diameter larger than the diameters of the bar connecting rod 71a and the insertion rod 71b, and is positioned outside the guide rail 70, and a disk-form inner flange 71d which is formed above the outer flange 71c, has a diameter slightly smaller than the outer diameter of the outer flange 71c, and is positioned in the guide groove. Around the outer periphery of the insertion rod 71b and above the inner flange 71d, there are disposed the first and second rolling elements 51, 52 in a freely rotatable manner. A snap ring 73 is fixed to a middle position of the upper end of the insertion rod 71b, and a flat washer 74 is disposed below the snap ring 73 and on the first rolling element 51, and also between the first rolling element 51 and the second rolling element 52. The outer diameters of the first and second rolling elements 51, 52 are set slightly smaller than the distance between the left vertically-suspended plate 70b and the right vertically-suspended plate 70c, so as to ensure a clearance between the guide groove and the first and second rolling elements 51, 52.

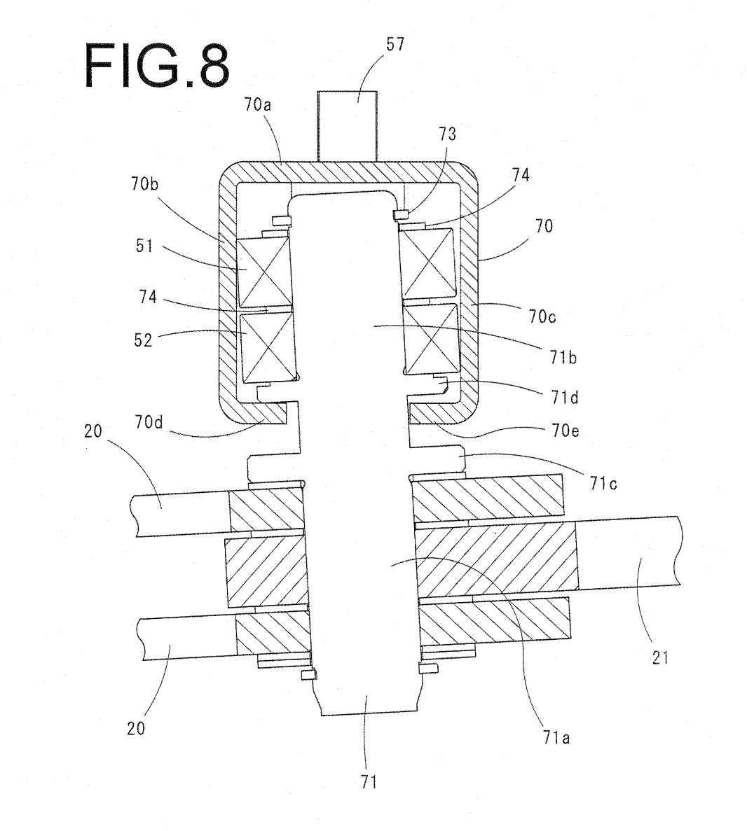

Also for the case having the guide rail 70, the connecting shaft 71 and the first and second rolling elements 51, 52 configured as described in the above, if the connecting shaft 71 having been vertically positioned in the depth-wise direction of the guide groove inclines as illustrated in FIG. 8, due to external force applied to any of the first to fourth protection covers 2, 3, 4, 5 composing the telescopic cover 1, the outer circumferential surface of the first rolling element 51 is brought into contact only with the one guiding surface (inner surface of the left vertically-suspended plate 70b), whereas the outer circumferential surface of the second rolling element 51 is brought into contact only with the other guiding surface (inner surface of the right vertically-suspended plate 70c) , so that not only the first rolling element 51, but also the second rolling element 52 are prevented from being brought into contact with both of the one guiding surface and the other guiding surface.

What is claimed is:

1. A telescopic cover having a plurality of protection covers each having a top plate and a vertically-suspended plate vertically suspended from said top plate, and being arranged so as to cover a guiding portion of a machining tool or the like in a freely stretchable manner between every adjacent pair of said protection covers, while being linked with each other by a linking mechanism which is configured by a plurality of linking elements linked so as to be rotatable around connecting shafts, said telescopic cover comprising:
a plurality of guide rails provided to said plurality of protection covers, each having a guide groove which comprises one and the other guiding surfaces opposed with each other, in the direction normal to the direction of stretching of the entire portion of the protection covers; and
a plurality of rolling elements arranged in said guide groove, so as to be freely rotatable around each connecting shaft which extends in the depth-wise direction of the guide groove.

2. The telescopic cover as claimed in claim 1, wherein each of said guide rails further comprises:
an opening formed between said one and the other guiding surfaces so as to allow said connecting shafts inserted thereinto; and
a closing portion opposed with said opening,
the width of the inner surface of said closing portion which configures said guide groove is smaller than the diameters of said plurality of rolling elements.
